(19) United States
(12) Patent Application Publication
(10) Pub. No.: US 2025/0125724 A1
(43) Pub. Date: Apr. 17, 2025

(54) HYBRID BUCK CONVERTER AND OPERATING METHOD THEREOF

(71) Applicant: Samsung Electronics Co., Ltd., Suwon-si (KR)

(72) Inventors: Doojin Jang, Suwon-si (KR); Hyunsik Kim, Daejeon-si (KR); Junhyeok Yang, Suwon-si (KR); Sungmin Yoo, Suwon-si (KR); Honghyun Bae, Daejeon-si (KR)

(73) Assignee: Korea Advanced Institute of Science and Technology, Daejeon (KR)

(21) Appl. No.: 18/909,152

(22) Filed: Oct. 8, 2024

(30) Foreign Application Priority Data
Oct. 11, 2023 (KR) 10-2023-0135395
Dec. 19, 2023 (KR) 10-2023-0186295

(51) Int. Cl. H02M 3/158; H02M 1/00

(52) U.S. Cl. CPC H02M 3/158; H02M 1/0095

(57) ABSTRACT

Provided is a hybrid buck converter including a first PMOS transistor and a second PMOS transistor electrically connecting a power supply voltage node with a first switching node, a first NMOS transistor and a second NMOS transistor electrically connecting a ground node with the first switching node, an inductor electrically connecting the first switching node with a second switching node, a third NMOS transistor electrically connecting the second switching node with a first output node, a third PMOS transistor electrically connecting the second switching node with a second output node, a shunt regulator that is driven based on a second output voltage of the second output node, a first PWM controller adjusting, based on a pulse width control of first PMOS transistor and first NMOS transistor, a magnitude of an inductor current, and a second PWM controller adjusting, based on a pulse width control of first PMOS transistor and first NMOS transistor, a magnitude of the second output voltage.

### CROSS-REFERENCE TO RELATED APPLICATIONS

This application is based on and claims priority under 35 U.S.C. § 119 to Korean Patent Application Nos. 10-2023-0135395, filed on Oct. 11, 2023, and 10-2023-0186295, filed on Dec. 19, 2023, in the Korean Intellectual Property Office, the disclosures of which are incorporated by reference herein in their entireties.

### BACKGROUND

Embodiments of the inventive concept relate to a hybrid buck converter, and more particularly, to a hybrid buck converter for high-speed transient response and high dynamic efficiency, and an operating method thereof.

High-performance parallel processing technologies, such as artificial intelligence and machine learning, have become common and are spreading to various areas besides image and speech recognition. Due to the nature of having to process a large amount of data at high speed, the use of a processor for high-performance computing is desired, and technical demands to be overcome are emerging. For example, the amount of power required by processors for high-performance computing is constantly increasing. In proportion to increasing power demand, high thermal design power and high heat consumption costs may be incurred, and many resources may be consumed for heat dissipation.

Dynamic voltage scaling technology in which power is varied according to processing throughput to effectively control power utilization may be used in high-performance computing processors, and to achieve higher efficiency, it may be necessary to improve the tracking speed of dynamic voltage scaling. A hybrid buck converter that adds a shunt regulator in parallel to the buck converter has been proposed to increase the tracking speed of dynamic voltage scaling.

However, compared to a buck converter that has an ideal power conversion efficiency of 100%, efficiency of the proposed hybrid buck converter exponentially decreases due to the frequent operation of the shunt regulator that causes power loss. Therefore, it may be necessary to reduce such efficiency reduction in hybrid buck converters that support dynamic voltage scaling.

### SUMMARY

The inventive concept provides a hybrid buck converter with high dynamic efficiency while maintaining a high-speed transient response, a method of operating the hybrid buck converter.

According to an aspect of the inventive concept, there is provided a hybrid buck converter including a buck converter including a first P-channel metal oxide semiconductor (PMOS) transistor and a second PMOS transistor electrically connecting a power supply voltage node with a first switching node, a first N-channel metal oxide semiconductor (NMOS) transistor and a second NMOS transistor electrically connecting a ground node with the first switching node, and an inductor electrically connecting the first switching node with a second switching node, a third NMOS transistor electrically connecting the second switching node with a first output node, a third PMOS transistor electrically connecting the second switching node with a second output node, a shunt regulator that is driven based on a second output voltage corresponding to the second output node, a first pulse width modulation (PWM) controller that adjusts the magnitude of an inductor current passing through the inductor based on a pulse width control of the first PMOS transistor and the first NMOS transistor, and a second PWM controller that adjusts the magnitude of the second output voltage based on a pulse width control of the first PMOS transistor and the first NMOS transistor.

According to another aspect of the inventive concept, there is provided an operation method of a hybrid buck converter, the operation method including determining whether an inductor current passing through an inductor of the buck converter is N times a shunt current output from the shunt regulator, performing a pulse width control between an high-side switching element and a low-side switching element of the buck converter according to the determining, performing a pulse width control between a third NMOS transistor and a third PMOS transistor based on the comparison result of a second output voltage and a second reference voltage, wherein the high-side switching element may electrically connect a power supply voltage with a first switching node corresponding to a first end of the inductor, the low-side switching element may electrically connect a ground node with the first switching node, the third PMOS transistor may electrically connect a second output node corresponding to the second output voltage with a second switching node corresponding to a second end of the inductor, and the third NMOS transistor may electrically connect the second switching node with a first output node corresponding to a first output voltage.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating an electronic device and an external power source, according to an embodiment;

FIG. 2 is a detailed block diagram of a power management integrated circuit (PMIC) according to an embodiment;

FIG. 3A is a circuit diagram of a hybrid buck converter according to a comparative example;

FIG. 3B is a graph illustrating operation of a hybrid buck converter according to a comparative example;

FIG. 4 is a circuit diagram of a hybrid buck converter according to an embodiment;

FIG. 5A is a circuit diagram of a hybrid buck converter including a push-pull controller, according to an embodiment;

FIG. 5B is a flowchart illustrating an operating method of a hybrid buck converter, according to an embodiment;

FIG. 6A is a circuit diagram of a hybrid buck converter including a first pulse width modulation (PWM) controller, according to an embodiment;

FIG. 6B is a flowchart illustrating an operating method of a hybrid buck converter, according to an embodiment;

FIG. 7A is a circuit diagram of a hybrid buck converter including a second PWM controller, according to an embodiment;

FIG. 7B is a flowchart illustrating an operating method of a hybrid buck converter, according to an embodiment;

FIG. 7C illustrates an example of a reduction in power loss, according to an embodiment;

FIG. 7D is a graph illustrating an example in which a second reference voltage is varied, according to an embodiment;

FIG. 8A is a circuit diagram of a hybrid buck converter including a hysteresis controller, according to an embodiment;

FIG. 8B illustrates an example of a third reference voltage, according to an embodiment;

FIG. 8C is a flowchart illustrating an operating method of a hybrid buck converter, according to an embodiment; and

FIG. 9 is a pair of graphs that illustrate efficiency improvement of a hybrid buck converter according to an embodiment.

### DETAILED DESCRIPTION OF THE EMBODIMENTS

Hereinafter, embodiments of the inventive concept will be described in detail with reference to the accompanying drawings. The same reference numerals are used for the same components in the drawings, and duplicate descriptions thereof are omitted. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination. In the present specification, although terms such as first and second are used to describe various elements or components, it goes without saying that these elements or components are not limited by these terms. These terms are only used to distinguish a single element or component from other elements or components.

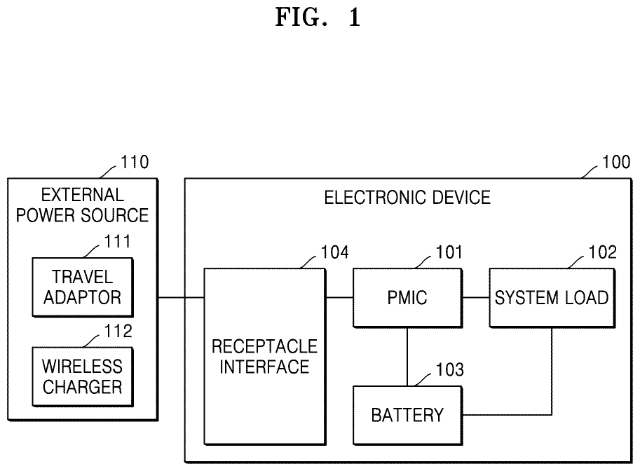

FIG. 1 is a block diagram illustrating an electronic device 100 and an external power source 110 according to an embodiment.

Referring to FIG. 1, an electronic device 100 and an external power source 110 are illustrated. To charge a battery 103 included in the electronic device 100, the electronic device 100 and the external power source 110 may be electrically connected to each other by wire or wirelessly.

In various embodiments, the electronic device 100 may include various electronic devices portable by a user. For example, the electronic device 100 may be a mobile device, such as a smartphone, a tablet personal computer PC, a mobile phone, a personal digital assistant (PDA), a laptop, a wearable device, a global positional system (GPS) device, an e-book terminal, a digital broadcast terminal, an M_{P3} player, a digital camera, or the like. For another example, the electronic device 100 may be an electric vehicle.

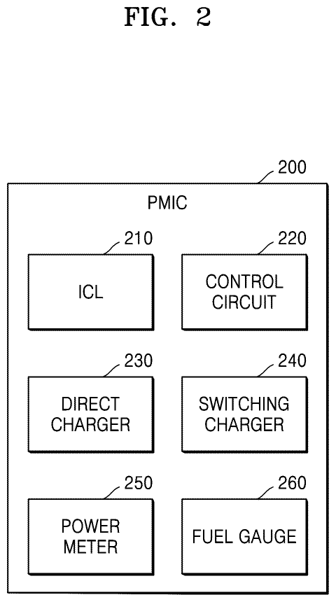

According to an embodiment, the electronic device 100 may include a power management integrated circuit (PMIC) 101. The PMIC 101 may be implemented as an integrated circuit chip and may be mounted on a printed circuit board (PCB). The PMIC 101 may charge the battery 103 by receiving power from the external power source 110 and transmitting the received power to the battery 103, and may transmit power to a system load 102 to control the electronic device 100 to perform various functions. A detailed configuration of the PMIC 101 will be described below in FIG. 2.

In addition, the electronic device 100 may include the battery 103. The battery 103 may include at least one battery cell. For example, the battery 103 may correspond to a multi-cell battery including a plurality of battery cells electrically connected in series to each other. As another example, the battery 103 may correspond to a single cell battery including one battery cell. The battery 103 may receive power through the PMIC 101 when the electronic device 100 is electrically connected to the external power source 110. The battery 103 may provide power to the system load 102 to control the electronic device 100 to perform various functions when the electronic device 100 is not connected to the external power source 110.

In addition, the electronic device 100 may include the system load 102. Although not shown, the system load 102 may include components other than the PMIC 101 and the battery 103 in the electronic device 100. For example, the system load 102 may include a display, an application processor, a communication processor, a speaker, a memory, and the like. That is, the system load 102 may refer to chips, modules, operation blocks, function blocks, and intellectual property (IP) blocks included in the electronic device 100. The system load 102 may receive power from the external power source 110 or the battery 103 and provide various functions to users. For example, a monitor of the system load 102 may provide visual recognition to the user by displaying an object through the display, the communication processor may transmit and receive data by exchanging wireless signals with external devices, and the application processor may perform various operations.

In addition, the electronic device 100 may include a receptacle interface 104. The receptacle interface 104 may electrically connect the electronic device 100 with the external power source 110 through a universal serial bus (USB) cable. In an embodiment, the receptacle interface 104 may correspond to a USB type-C interface, and the USB cable may correspond to a USB type-C cable. The USB Type-C interface may be implemented based on the definition of USB 2.0, USB 3.1, or USB 3.2. The receptacle interface 104 may include a plurality of pins. The plurality of pins may include a pin for power supply, a pin for data transmission, and a configuration channel (CC) pin.

The external power source 110 may supply power to the electronic device 100. According to various embodiments, the external power source 110 may include a travel adaptor (TA) 111 and a wireless charger 111. Instead of supplying power through a wire, the wireless charger 112 may wirelessly transmit power through air to charge the electronic device 100. According to various embodiments, the wireless charger 112 may transmit power based on various wireless charging methods such as a magnetic induction method, a magnetic resonance method, and an electromagnetic induction method, and a non-radioactive wireless charging method (WiTricity).

The TA 111 may supply power through a wire connected to the PMIC 101 of the electronic device 100. The TA 111 may convert power supplied from alternating-current (AC) 110V to 220V, which may be a household power source, or other power supply devices (e.g., a computer) into direct-current (DC) power required for charging the battery 103 and provide the converted DC power to the electronic device 100. According to various embodiments, the receptacle interface 104 may be electrically connected to an output terminal of an auxiliary battery.

FIG. 2 is a detailed block diagram of a power management integrated circuit (PMIC) 200 according to an embodiment.

A PMIC 200 of FIG. 2 may correspond to the PMIC 101 included in the electronic device 100 of FIG. 1. Referring to FIG. 2, the PMIC 200 may include a control circuit 220, a direct charger 230, a switching charger 240, an input current limiter (ICL) 210, a fuel gauge 260, and a power meter 250.

The ICL 210 may adjust the magnitude of the input current. For example, when the system load 102 also operates at the same time as the battery 103 is charged, the magnitude of the input current input to the PMIC 200 may correspond to a sum of a charging current for charging the battery and a load current transmitted to the system load 102. When the magnitude of the input current increases, the overload of the PMIC 101 may increase the risk of a fire. Therefore, the ICL 210 may control the magnitude of the input current not to exceed a predetermined magnitude. Although not shown, the ICL 210 may include an internal transistor resistance. When the magnitude of the input current exceeds a predetermined magnitude, the magnitude of the internal transistor resistance may be increased according to a control signal received from the control circuit 220. Because the magnitude of the external power voltage is constant, the magnitude of the input current may be reduced by increasing the magnitude of the internal transistor resistance.

The control circuit 220 may control the overall operation of the PMIC 200. The control circuit 220 may communicate with the TA 111 through the receptacle interface 104. For example, the control circuit 220 may control the output voltage and output current of the TA 111 by transmitting control information to the TA 111.

The switching charger 240 includes a buck converter, and may step down an input voltage, and adjust a charging current by adjusting a cycle of the buck converter. Because the switching charger 240 includes an inductor, it may not be possible to remove a switching loss and a conduction loss caused by the resistance component of the inductor itself. Accordingly, the charging efficiency of the switching charger 240 may be lower than that of the direct charger 230.

The direct charger 230 may directly transmit an input voltage to the battery 103 via a cap divider. Because the direct charger 230 includes only a transistor and a capacitor, the switching loss and the conduction loss due to the resistance component of the inductor itself may be saved. Because the input voltage may be directly transmitted to the node of the battery 103 through the cap divider, the direct charger 230 may be suitable for a high-efficiency charging system.

The fuel gauge 260 may sense a state of the battery 103. For example, the fuel gauge 260 may sense a state of charge (SoC), a charge voltage, a charge current, and a battery temperature of the battery 103. The SoC is a ratio of the current capacity to the maximum capacity of the battery 103, and may be defined in units of a percentage (%).

Although not shown, the fuel gauge 260 may include an analog-to-digital converter (ADC). The fuel gauge 260 may digitally convert analog information of sensed voltage, current, and temperature through the ADC and transmit the digital information to the direct charger 230, the switching charger 240, and/or the system load 102. The fuel gauge 260 may be implemented as part of an integrated circuit chip and may be mounted on a printed circuit board. However, embodiments are not limited thereto, and the fuel gauge 260 and the PMIC 200 may be implemented as different integrated circuits or integrated circuit chips.

The power meter 250 may obtain information on an input/output voltage and current. The power meter 250 may sense the magnitude of the voltage and current input to the PMIC 200, and the magnitude of the voltage and current transmitted to the system load 102.

Although not shown, the power meter 250 includes an ADC, and may digitally convert information on the sensed voltage, current, and power using the ADC and transmit the digital information to the direct charger 230, the switching charger 240, and/or the system load 102. The power meter 250 may be implemented as part of an integrated circuit chip and may be mounted on a printed circuit board. However, embodiments are not limited thereto, and the power meter 250 and the PMIC 200 may be implemented as different integrated circuits or integrated circuit chips.

Although not shown, the PMIC 200 may further include a circuit or block that supports at least one of various functions such as an under-voltage lockout (UVLO) function, an over-current protection (OCP) function, an over-voltage protection (OVP) function, a soft-start function that reduces rush current, a foldback current limit function, a Hiccup Mode function for short-circuit protection, an over-temperature protection (OTP) function, etc., to operate properly even under power savings conditions.

According to an embodiment, the switching charger 240 may include a DC-DC converter. For example, the DC-DC converter may correspond to a hybrid buck converter. The hybrid buck converter is a type of heterogeneous-parallel converter, and may refer to, for example, a DC-DC converter in which different buck converters and shunt regulators are connected in parallel. Hereinafter, a hybrid buck converter according to a comparative example and a hybrid buck converter according to embodiments of the inventive concept will be described.

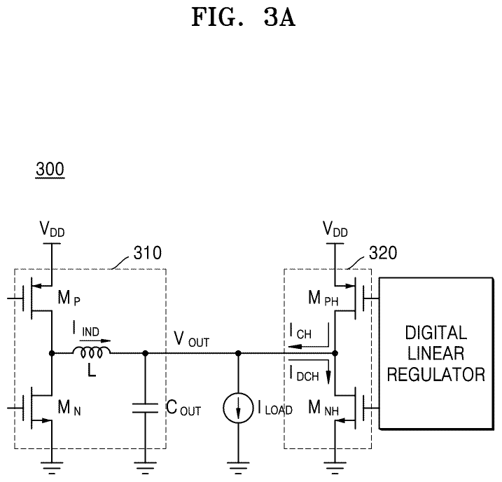

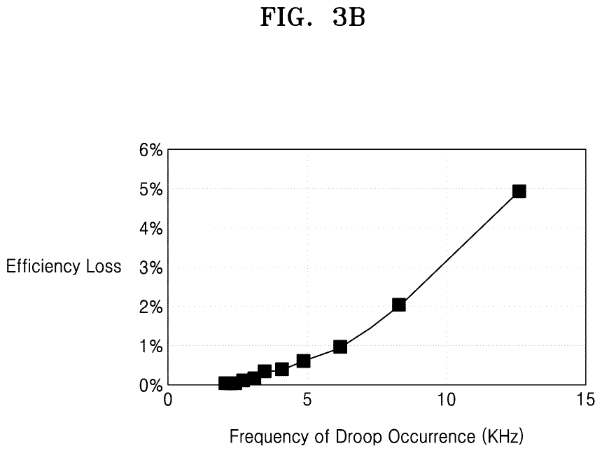

FIG. 3A is a circuit diagram of a hybrid buck converter 300 according to a comparative example, and FIG. 3B is a graph illustrating an efficiency loss depending on a frequency of operating voltage scaling according to a comparative example.

Referring to FIG. 3A, a hybrid buck converter 310 according to a comparative example may include a buck converter 310 and a shunt regulator 320 connected in parallel with each other.

The buck converter 310 may include a PMOS transistor M_{P}, an NMOS transistor M_{N}, an inductor L, and a capacitor C_{OUT}. The PMOS transistor M_{P} and the NMOS transistor M_{N} may be alternately turned on. For example, if the load current I_{LOAD} input to the system load 102 needs to be increased, the PMOS transistor M_{P} and the NMOS transistor M_{N} may be alternately turned on such that the time for the PMOS transistor M_{P} to be turned on increases and the time for the NMOS transistor M_{N} to be turned on decreases. For another example, if the load current I_{LOAD} input to the system load 102 needs to be decreased, the PMOS transistor M_{P} and the NMOS transistor M_{N} may be alternately turned on such that the time for the PMOS transistor M_{P} to be turned on decreases and the time for the NMOS transistor M_{N} to be turned on increases.

The shunt regulator 320 may include a PMOS transistor M_{PH} and an NMOS transistor M_{NH}. The shunt regulator 320 may control the PMOS transistor M_{PH} and the NMOS transistor M_{NH} for a high-speed transient response. For example, if the load current I_{LOAD} input to the system load 102 needs to be increased, the shunt regulator 320 may control the PMOS transistor M_{PH} to be turned on to add the charge current I_{CH} to the transient load current I_{LOAD} so that the load current I_{LOAD} quickly enters a steady state. For another example, if the load current I_{LOAD} input to the system load 102 needs to be decreased, the shunt regulator 320 may control the NMOS transistor M_{NH} to be turned on to subtract the discharge current I_{DCH} from the transient load current I_{LOAD} so that the load current I_{LOAD} quickly enters a steady state.

Referring to FIG. 3B, the X-axis of the graph represents a frequency of dynamic voltage scaling, and the Y-axis of the graph represents an efficiency loss. For example, the hybrid buck converter 300 according to the comparative example operates to add the charge current I_{CH} to the load current I_{LOAD} through the shunt regulator 320 or subtract the discharge current I_{DCH} from the load current I_{LOAD} whenever dynamic voltage scaling occurs. However, power loss occurs every time the shunt regulator 320 is operated, and the power loss may be proportional to the magnitude of the voltage drop (e.g., the difference between the power voltage V_{DD} and the output voltage V_{OUT}) and may be proportional to the shunt current (e.g., the difference between the charge current I_{CH} and the discharge current I_{DCH}). That is, referring to FIG. 3B, it may be confirmed that the efficiency loss rapidly increases as the frequency of occurrence of dynamic voltage scaling increases.

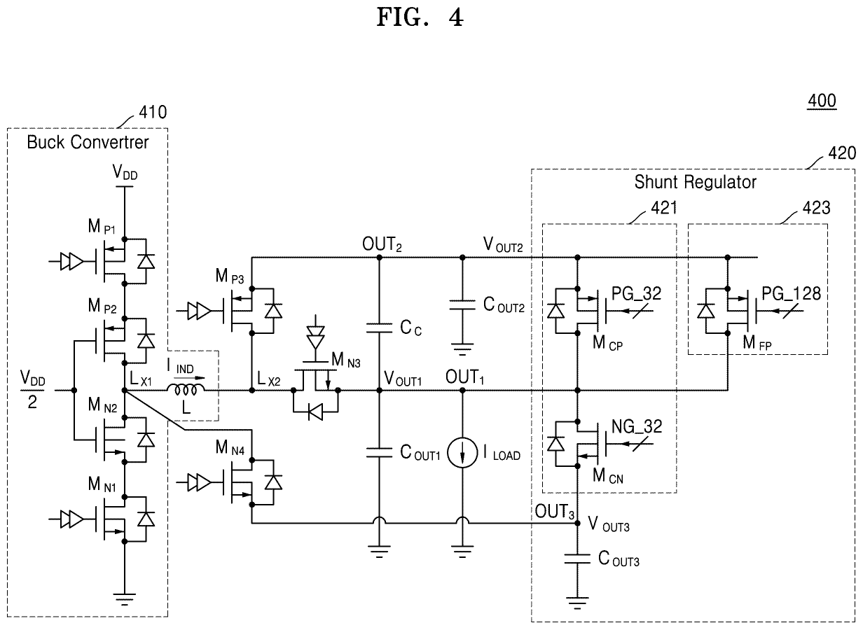

FIG. 4 is a circuit diagram of a hybrid buck converter 400 according to an embodiment.

Referring to FIG. 4, the hybrid buck converter 400 may include a buck converter 410 and a shunt regulator 420. Additionally, the hybrid buck converter 400 may further include a third NMOS transistor M_{N3}, a third PMOS transistor M_{P3}, a fourth NMOS transistor M_{N4}, a coupling capacitor C_{C}, a second output capacitor C_{OUT2}, and a third output capacitor C_{OUT3}, in addition to the hybrid buck converter 300 according to the comparative example.

According to an embodiment, a first NMOS transistor M_{N1} and a second NMOS transistor M_{N2} of the hybrid buck converter 400 may be referred to as a low-side switching element. A first PMOS transistor M_{P1} and a second PMOS transistor M_{P2} of the hybrid buck converter 400 may be referred to as a high-side switching element.

According to an embodiment, the hybrid buck converter 400 may further include the third NMOS transistor M_{N3}, the third PMOS transistor M_{P3}, and the coupling capacitor C_{C} of the second output capacitor C_{OUT2}. The third NMOS transistor M_{N3} may be electrically connected between the second switching node L_{X2} and the first output node OUT₁. The third PMOS transistor M_{P3} may be electrically connected between the second switching node L_{X2} and the second output node OUT₂. According to an embodiment, the third NMOS transistor M_{N3} and the third PMOS transistor M_{P3} may be alternately turned on. As the third NMOS transistor M_{N3} and the third PMOS transistor M_{P3} are alternately turned on, the voltage level of the second output node OUT₂ may be controlled. A voltage of the second output node OUT₂ may correspond to the second output voltage V_{OUT2}. The second output node OUT₂ may be a node for driving the shunt regulator 420. That is, the shunt regulator 420 may be driven based on the second output voltage V_{OUT2}. The coupling capacitor C_{C} is a capacitor for coupling between the first output node OUT₁ and the second output node OUT₂. The coupling capacitor C_{C} may correspond to an electrical path through which an AC current between the first output voltage V_{OUT1} of the first output node OUT₁ and the second output voltage V_{OUT2} of the second output node OUT₂ passes. That is, the first output voltage V_{OUT1} and the second output voltage V_{OUT2} may be regulated based on the duty cycles of the third PMOS transistor M_{P3} and the third NMOS transistor M_{N3}, the first output capacitor C_{OUT1}, the second output capacitor C_{OUT2}, and the coupling capacitor C_{C}.

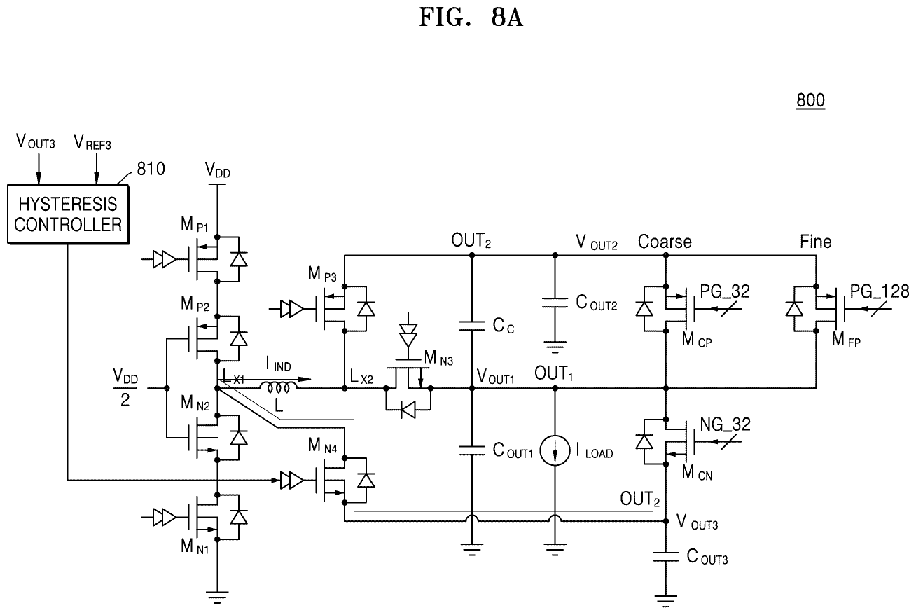

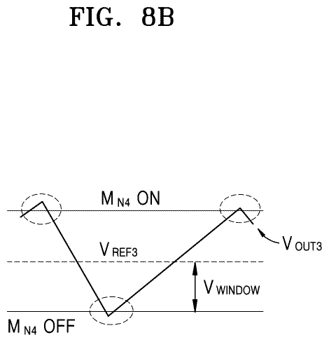

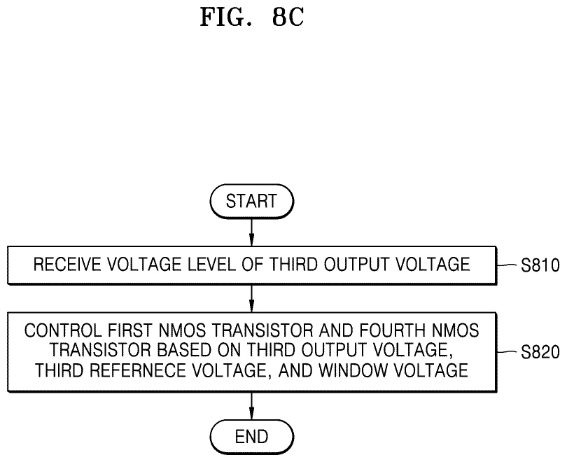

According to an embodiment, the hybrid buck converter 400 may further include a fourth NMOS transistor M_{N4} and a third output capacitor C_{OUT3}. The fourth NMOS transistor M_{N4} may electrically connect the first switching node V_{X1} with the third output node OUT₃. The fourth NMOS transistor M_{N4} may be turned on or off based on the voltage level of the third output capacitor COUT₃. For example, when the third output capacitor C_{OUT3} is charged and the voltage level of the third output node OUT₃ exceeds a first threshold value, the fourth NMOS transistor M_{N4} may be turned on. When the fourth NMOS transistor M_{N4} is turned on, the inductor current I_{IND} may be generated using the charge stored in the third output capacitor C_{OUT3}. That is, the fourth NMOS transistor M_{N4} may store the discharged current through the third output capacitor C_{OUT3}, and when the charge stored in the third output capacitor C_{OUT3} exceeds a predetermined reference, the fourth NMOS transistor M_{N4} may be turned on to reuse the stored charge as the inductor current I_{IND}. A detailed description thereof will be described below with reference to FIGS. 8A to 8C.

According to an embodiment, the shunt regulator 420 may include a coarse regulator 421 and a fine regulator 423. The coarse regulator 421 may include a coarse PMOS transistor M_{CP} connecting the second output node OUT₂ with the first output node OUT₁ and a coarse NMOS transistor M_{CN} connecting the first output node OUT₁ with the third output node OUT₃. The coarse PMOS transistor M_{CP} may adjust the magnitude of the charge current for regulating the voltage level of the first output node OUT₁. For example, the coarse PMOS transistor M_{CP} may include 32 PMOS transistors. The coarse PMOS transistor M_{CP} may control the magnitude of the shunt current I_{SHUNT} input to the first output node OUT₁ based on the turn-on or turn-off of the 32 PMOS transistors. For example, as the number of turned-on transistors among the 32 PMOS transistors increases, the charge current input to the first output node OUT₁ increases, thereby increasing the magnitude of the shunt current I_{SHUNT}.

The coarse NMOS transistor M_{CN} may adjust the magnitude of the discharge current for regulating the voltage level of the first output node OUT₁. For example, the coarse NMOS transistor M_{CN} may include 32 NMOS transistors. The coarse NMOS transistor M_{CN} may control the magnitude of the shunt current I_{SHUNT} input to the first output node OUT₁ based on the turn-on or turn-off of the 32 NMOS transistors. For example, as the number of turned-on transistors among the 32 NMOS transistors increases, the discharge current discharged from the first output node OUT₁ to the third output node OUT₃ increases, and the magnitude of the shunt current I_{SHUNT} may decrease.

The fine regulator 423 may include a fine PMOS transistor M_{FP} connecting the second output node OUT₂ with the first output node OUT₁. The fine PMOS transistor M_{FP} may adjust the magnitude of the charge current for regulating the voltage level of the first output node OUT₁. For example, the fine PMOS transistor M_{FP} may include 128 PMOS transistors. The fine PMOS transistor M_{FP} may control the magnitude of the shunt current I_{SHUNT} input to the first output node OUT₁ based on the turn-on or turn-off of the 128 PMOS transistors. For example, as the number of turned-on transistors among the 128 PMOS transistors increases, the charge current input to the first output node OUT₁ increases, thereby increasing the magnitude of the shunt current I_{SHUNT}. Since the fine PMOS transistor M_{FP} includes more transistors than the coarse PMOS transistor M_{CP}, the charge current may be adjusted more finely or with more precision.

In the embodiment described above, each of the coarse PMOS transistor M_{CP} and the coarse NMOS transistor M_{CN} includes 32 power MOSFETs, and the fine PMOS transistor M_{FP} includes 128 power MOSFETs, but embodiments are not limited thereto. According to various embodiments, the number of power MOSFETs included in the coarse PMOS transistor M_{CP}, the coarse NMOS transistor M_{CN}, and the fine PMOS transistor M_{FP} may be variably set. In some embodiments, however, the number of power MOSFETs in the fine PMOS transistor M_{FP} may be greater than the number of power MOSFETs in the coarse PMOS transistor M_{CP}.

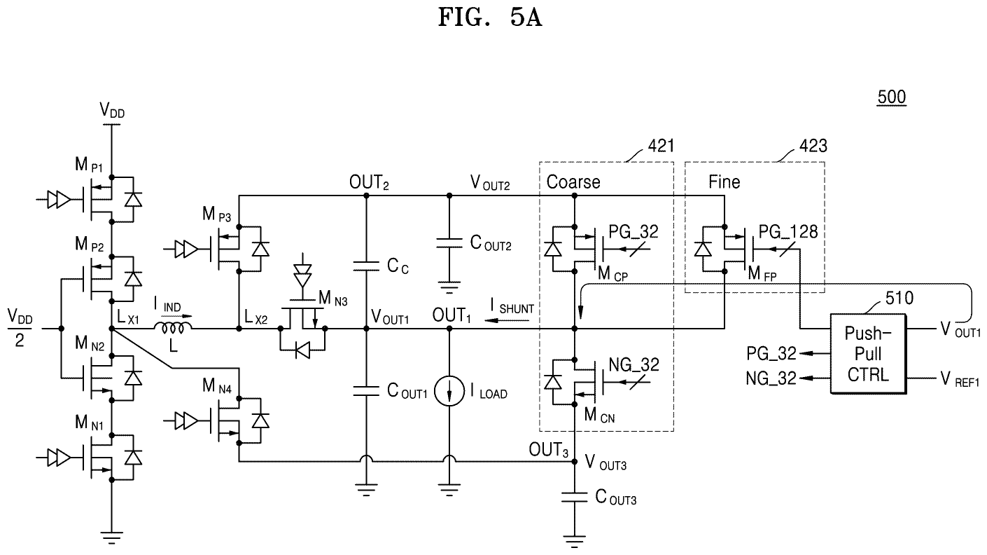

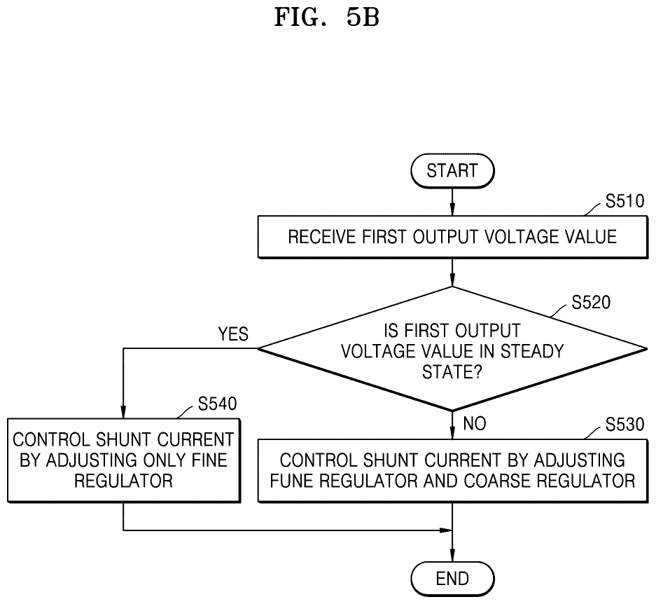

FIG. 5A is a circuit diagram of a hybrid buck converter 500 including a push-pull controller 510 according to an embodiment.

Referring to FIG. 5A, the hybrid buck converter 500 may further include a push-pull controller 510 in addition to the hybrid buck converter 400 of FIG. 4.

According to an embodiment, the push-pull controller 510 may control turn-on or turn-off of the shunt regulator 420. The push-pull controller 510 may be referred to in various terms, such as a shunt controller, a transient controller, and the like. The push-pull controller 510 may receive the first output voltage V_{OUT1} that is a voltage of the first output node OUT₁. The push-pull controller 510 may receive the voltage value of the first output voltage V_{OUT1} from the power meter 250 of the PMIC 200 (of FIG. 2). The push-pull controller 510 may receive a first reference voltage V_{REF1}. The push-pull controller 510 may receive the first reference voltage V_{REF1} from the control circuit 220 of the PMIC 200 (of FIG. 2). The first reference voltage V_{REF1} may be varied by the control circuit 220. For example, the control circuit 220 may determine to perform dynamic voltage scaling. The control circuit 220 may change the first output voltage V_{OUT1} of the first output node OUT₁ by increasing or decreasing the value of the first reference voltage V_{REF1}, and thus change the load current I_{LOAD}.

According to an embodiment, the push-pull controller 510 may not generate the control signal PG_32 or NG_32 of the coarse regulator 421. For example, the hybrid buck converter 500 may be in a steady state. The steady state may refer to a state in which the first output node OUT₁ and the load current I_{LOAD} are not significantly changed and are stable as the first output voltage V_{OUT1} becomes close to the first reference voltage V_{REF1}. When the hybrid buck converter 500 is in a steady state, it is not necessary to rapidly reduce or increase the shunt current I_{SHUNT} by driving the coarse regulator 421, and thus, the push-pull controller 510 may not generate a control signal PG_32 or NG_32 for driving the coarse regulator 421. However, even in the steady state, the hybrid buck converter 500 may generate the control signal PG_128 of the fine regulator 423 for the first output voltage V_{OUT1} to successfully track the first reference voltage V_{REF1}.

According to an embodiment, the push-pull controller 510 may generate both the control signal PG_32 or NG_32 of the coarse regulator 421 and the control signal PG_128 of the fine regulator 423. For example, the hybrid buck converter 500 may be in a transient state. The transient state may refer to a state in which the first output voltage V_{OUT1} is spaced apart from the first reference voltage V_{REF1}. That is, the transient state may correspond to a case where the difference between the first output voltage V_{OUT1} and the first reference voltage V_{REF1} is large or increased. For example, the control circuit 220 may change the first reference voltage V_{REF1} by determining dynamic voltage scaling. In this case, it may be necessary to change the shunt current I_{SHUNT} so that the first output voltage V_{OUT1} and the load current I_{LOAD} may quickly enter a steady state. The push-pull controller 510 may compare the first reference voltage V_{REF1} with the first output voltage V_{OUT1}, and generate a control signal PG_32 or NG_32 for driving the coarse regulator 421 based on the comparison result. However, even in this case, the control signal PG_128 for the fine regulator 423 may be generated. For example, the control signal PG_128 may be generated together with the control signal PG_32 or NG_32 for the coarse regulator 421. For example, the first reference voltage V_{REF1} may be increased by the control circuit 220. The push-pull controller 510 may increase the magnitude of the shunt current I_{SHUNT} to boost the first output voltage V_{OUT1} according to the first reference voltage V_{REF1}. To this end, the push-pull controller 510 may increase the number of PMOS transistors turned on among 32 PMOS transistors included in the coarse PMOS transistor M_{CP}. For another example, the first reference voltage V_{REF1} may be lowered by the control circuit 220. The push-pull controller 510 may reduce the magnitude of the shunt current I_{SHUNT} to reduce the first output voltage V_{OUT1} according to the first reference voltage V_{REF1}. To this end, the push-pull controller 510 may increase the number of NMOS transistors turned on among 32 NMOS transistors included in the coarse NMOS transistor M_{CN}.

FIG. 5B is a flowchart illustrating a method of operating a hybrid buck converter 500 according to an embodiment.

Referring to FIG. 5B, in operation S510, the hybrid buck converter 500 may receive a value of the first output voltage V_{OUT1}. The push-pull controller 510 of the hybrid buck converter 500 may compare the first output voltage V_{OUT1} with the first reference voltage V_{REF1}.

In operation S520, the hybrid buck converter 500 may determine whether the first output voltage V_{OUT1} is in a steady state. For example, when the difference between the first output voltage V_{OUT1} and the first reference voltage V_{REF1} is less than or equal to a threshold value, the push-pull controller 510 of the hybrid buck converter 500 may be determined to be in a steady state. For another example, in response to receiving a control signal for changing the first reference voltage V_{REF1} based on dynamic voltage scaling from the control circuit 220, the push-pull controller 510 of the hybrid buck converter 500 may determine a transient state rather than a steady state.

In operation S530, the hybrid buck converter 500 may control the shunt current I_{SHUNT} by adjusting the fine regulator 423 and the coarse regulator 421 together. In operation S520, the push-pull controller 510 may determine that the hybrid buck converter 500 is currently in a transient state. The push-pull controller 510 may increase or decrease the shunt current I_{SHUNT} so that the first output voltage V_{OUT1} converges to the first reference voltage V_{REF1} as quickly as possible. For example, when the first output voltage V_{OUT1} is greater than the first reference voltage V_{REF1}, the control signal NG_32 for driving the coarse NMOS transistor M_{CN} may be generated to lower the first output voltage V_{OUT1}. For another example, when the first output voltage V_{OUT1} is lower than the first reference voltage V_{REF1}, the control signal PG_32 for driving the coarse PMOS transistor M_{PN} and the control signal PG_128 for driving the fine PMOS transistor M_{FP} may be generated to increase the first output voltage V_{OUT1}.

In operation S540, the hybrid buck converter 500 may control the shunt current I_{SHUNT} by adjusting only the fine regulator 423. In operation S520, the push-pull controller 510 may determine that the hybrid buck converter 500 is currently in a steady state. Since the first output voltage V_{OUT1} is already in a steady state, the push-pull controller 510 does not need to rapidly increase or decrease the shunt current I_{SHUNT}. Therefore, the push-pull controller 510 generates only the control signal PG_128 for driving the fine PMOS transistor M_{FP} to control the shunt current I_{SHUNT}, so that the first output voltage V_{OUT1} may successfully track the first reference voltage V_{REF1}.

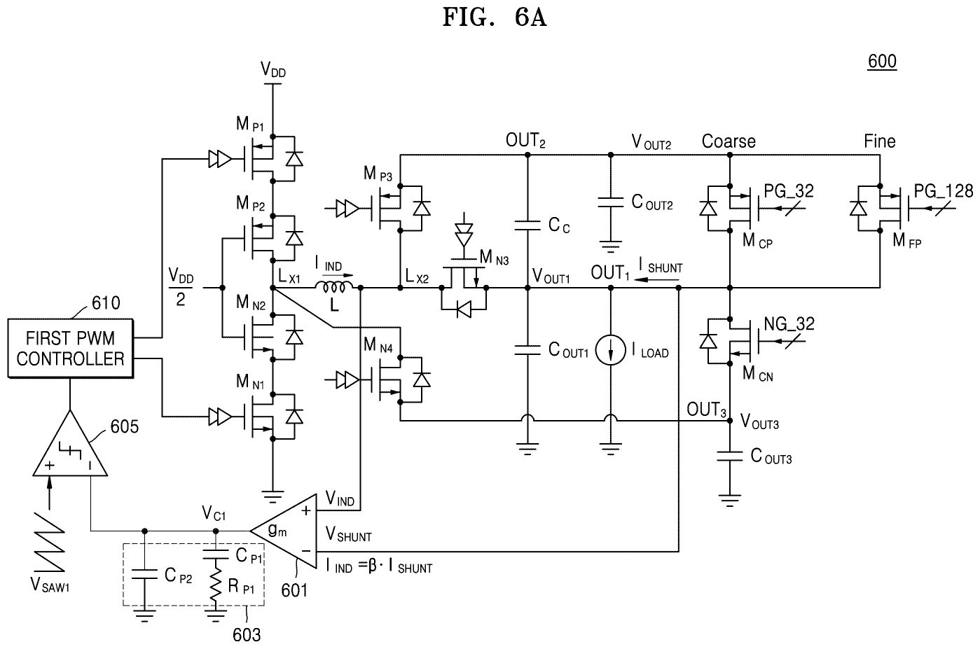

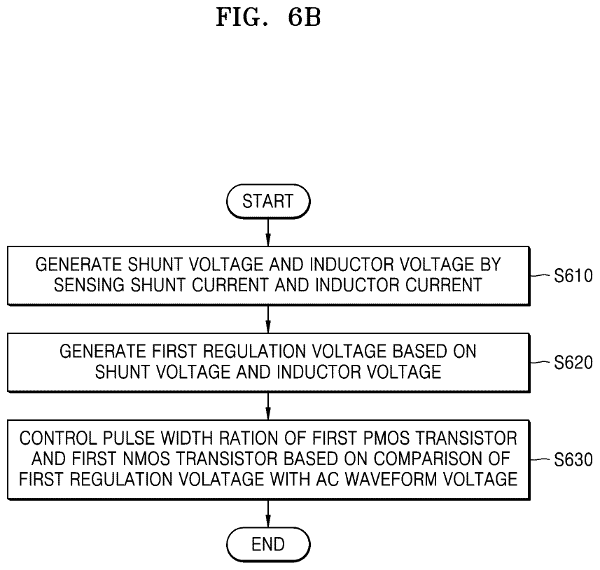

FIG. 6A is a circuit diagram of a hybrid buck converter 600 including a first PWM controller 610 according to an embodiment.

Referring to FIG. 6A, the hybrid buck converter 600 may further include a transconductance (GM) cell 601, a compensation network 603, a comparator 605, and a first PWM controller 610 in addition to the hybrid buck converter 400 of FIG. 4.

According to an embodiment, the GM cell 601 may correspond to an operational amplifier. The GM cell 601 may receive differential input voltages and output a first regulation voltage V_{C1}. The first PWM controller 610 may control the duty cycle based on the first regulation voltage V_{C1}. One of the differential input voltages may correspond to the shunt voltage V_{SHUNT}. The shunt voltage V_{SHUNT} may be a value obtained by sensing the shunt current I_{SHUNT} and converting the shunt current into a voltage. The other of the differential input voltages may correspond to the inductor voltage V_{IND}. The inductor voltage V_{IND} may be a value obtained by sensing the inductor current I_{IND} and converting the inductor current I_{IND} into a voltage. According to an embodiment, a ratio for converting the inductor current I_{IND} into a voltage and a ratio for converting the shunt current I_{SHUNT} into a voltage may be different. According to an embodiment, the inductor current I_{IND} may be converted into the inductor voltage V_{IND} based on a ratio of 1:1. The shunt current I_{SHUNT} may be converted into a shunt voltage V_{SHUNT} based on a ratio of 1:#. That is, the inductor current I_{IND} and the shunt current I_{SHUNT} may be regulated to satisfy the following Equation 1.

$${I}_{IND} = β * {I}_{SHUNT} \qquad [ Equation 1 ]$$

The hybrid buck converter 600 may regulate the magnitude of the inductor current I_{IND} to be β times the magnitude of the shunt current I_{SHUNT}, thereby reducing the magnitude of power loss generated by the shunt regulator 420. Power loss PL generated by the shunt regulator 420 is as the following Equation 2.

$$PL = {I}_{SHUNT} * ( {V}_{OUT 2} - {V}_{OUT 1} ) \qquad [ Equation 2 ]$$

That is, the hybrid buck converter 600 processes most of the load current I_{LOAD} (for example,

$$\frac{β}{1 + β} )$$

at the inductor current I_{IND}, and processes only a small part of the load current I_{LOAD} (for example,

$$\frac{1}{1 + β} )$$

to the shunt current I_{SHUNT} to reduce the magnitude of the shunt current I_{SHUNT}, thereby reducing power loss. For example, the value of may be 100, but is not limited thereto. Depending on the operation environment, the value of may be less than 100 or may be set to be greater than 100. The value of f may vary according to the user's setting of the electronic device 100 of FIG. 1.

According to an embodiment, the compensation network 603 may determine a response speed of the alternating-current (AC) component of the first regulation output V_{C1}. The compensation network 603 may include a first compensation capacitor C_{P1}, a second compensation capacitor C_{P2}, and a first compensation resistor R_{P1}.

The comparator 605 may compare input signals with each other to generate an output signal indicating a comparison result. The comparator 605 may receive differential inputs. One of the differential inputs may be an AC waveform. For example, the AC waveform may be a sawtooth waveform, but is not limited thereto. According to various embodiments, the AC waveform may further include triangular waveform, square waveform, or the like. According to an embodiment, the comparator 605 may compare the first regulation voltage V_{C1} with the magnitude of the voltage V_{SAW1} of the AC waveform and provide a comparison result to the first PWM controller 610.

According to an embodiment, the first PWM controller 610 may control a duty cycle between the first PMOS transistor M_{P1} and the first NMOS transistor M_{N1}. For example, the first PWM controller 610 may increase the turn-on time of the first PMOS transistor M_{P1} when the inductor current I_{IND} is less than β times the shunt current I_{SHUNT}. That is, the first PWM controller 610 may increase the time for the first PMOS transistor M_{P1} to be turned on within one cycle in which the first NMOS transistor M_{N1} and the first PMOS transistor M_{P1} are alternately turned on to increase the magnitude of the inductor current I_{IND}. For another example, the first PWM controller 610 may reduce the turn-on time of the first PMOS transistor M_{P1} when the inductor current I_{IND} is greater than β times the shunt current I_{SHUNT}. That is, the first PWM controller 610 may reduce the time for the first PMOS transistor M_{P1} to be turned on within one cycle in which the first NMOS transistor M_{N1} and the first PMOS transistor M_{P1} are alternately turned on to reduce the magnitude of the inductor current I_{IND}.

FIG. 6B is a flowchart illustrating a method of operating a hybrid buck converter 600 according to an embodiment.

Referring to FIG. 6B, in operation S610, the hybrid buck converter 600 may generate the shunt voltage V_{SHUNT} and the inductor voltage V_{IND} by sensing the shunt current I_{SHUNT} and the inductor current I_{IND}. For example, the hybrid buck converter 600 may further include a first current-voltage converter and a second current-voltage converter. The first current-voltage converter may convert the inductor current I_{IND} into the inductor voltage V_{IND}. In this case, the conversion ratio of the first current-voltage converter may be 1:1. The second current-voltage converter may convert the shunt current I_{SHUNT} into the shunt voltage V_{SHUNT}. In this case, the conversion ratio of the second current-voltage converter may be 1: #. That is, the second current-voltage converter may generate the shunt voltage V_{SHUNT} by multiplying the shunt current I_{SHUNT} by β.

In operation S620, the GM cell 601 of the hybrid buck converter 600 may generate the first regulation voltage V_{C1} based on the shunt voltage V_{SHUNT} and the inductor voltage V_{IND}. For example, the GM cell 601 of the hybrid buck converter 600 may receive, as inputs, the shunt voltage V_{SHUNT} and the inductor voltage V_{IND} obtained in operation S610 and output the first regulation voltage V_{C1}.

In operation S630, the hybrid buck converter 600 may control a pulse width ratio of the first PMOS transistor M_{P1} and the first NMOS transistor M_{N1} based on a comparison between the first regulation voltage V_{C1} and the AC waveform voltage V_{SAW1}. For example, when the first regulation voltage V_{C1} exceeds the intermediate value of the AC waveform voltage V_{SAW1} (e.g., when the inductor current I_{IND} is greater than β times the shunt current I_{SHUNT}), the first PWM controller 610 may control the pulse width ratio so that the turn-on time of the first PMOS transistor M_{P1} is reduced. For another example, when the first regulation voltage V_{C1} is less than the intermediate value of the AC waveform voltage V_{SAW1} (e.g., when the inductor current I_{IND} is less than β times the shunt current I_{SHUNT}), the first PWM controller 610 may control the pulse width ratio so that the turn-on time of the first PMOS transistor M_{P1} is increased.

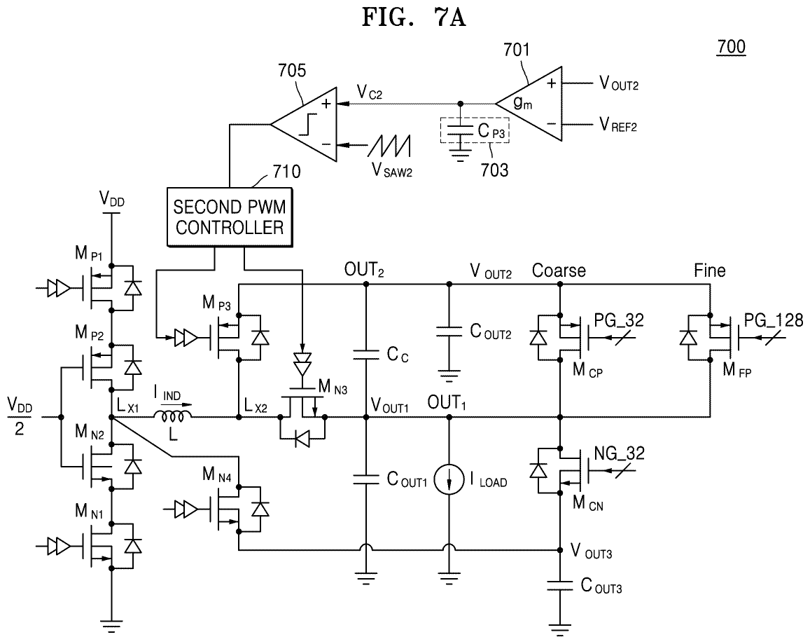

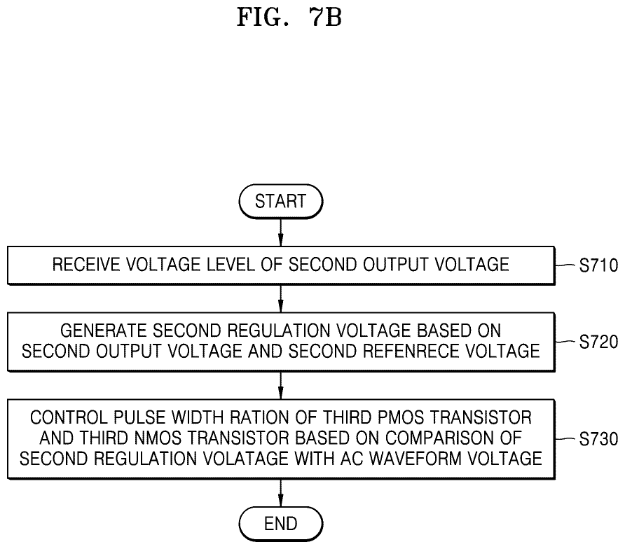

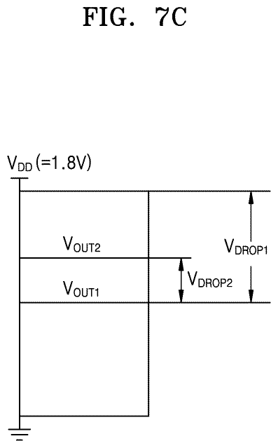

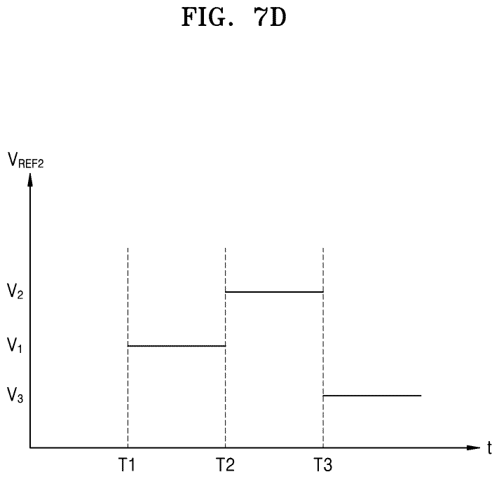

FIG. 7A is a circuit diagram of a hybrid buck converter 700 including a second PWM controller 710 according to an embodiment.

Referring to FIG. 7A, the hybrid buck converter 700 may further include a GM cell 701, a compensation network 703, a comparator 705, and a second PWM controller 710 in addition to the hybrid buck converter 400 of FIG. 4.

According to an embodiment, the GM cell 701 may correspond to an operational amplifier. The GM cell 701 may receive differential input voltages and output a second regulation voltage V_{C2}. The second PWM controller 710 may control duty cycles of the third PMOS transistor M_{P3} and the third NMOS transistor M_{N3} based on the second regulation voltage V_{C2}. One of the differential inputs may correspond to the second output voltage V_{OUT2}. The second output voltage V_{OUT2} may be a value obtained by sensing a voltage of the second output node OUT₂. The other one of the differential inputs may be the second reference voltage V_{REF2}. The second reference voltage V_{REF2} may be a voltage that is a reference for controlling the voltage level of the second output voltage V_{OUT2}. The second reference voltage V_{REF2} may be varied by the control circuit 220 of FIG. 2. For example, the control circuit 220 may set the second reference voltage V_{REF2} to be close to the power supply voltage V_{DD} or to be close to the first output voltage V_{OUT1} based on the frequency of dynamic voltage scaling. The second reference voltage V_{REF2} will be described in detail below with reference to FIG. 7D.

According to an embodiment, the compensation network 703 may determine a response speed of the AC component of the second regulation output V_{C2}. The compensation network 703 may include a third compensation capacitor C_{P3}.

The comparator 705 may compare input signals with each other to generate an output signal indicating a comparison result. The comparator 705 may receive differential inputs. One of the differential inputs may be an AC waveform. For example, the AC waveform may be a sawtooth waveform, but is not limited thereto. According to various embodiments, the AC waveform may further include triangular waveform, square waveform, or the like. According to an embodiment, the comparator 705 may compare the second regulation voltage V_{C2} with the magnitude of the voltage V_{SAW2} of the AC waveform and provide a comparison result to the second PWM controller 710.

According to an embodiment, the second PWM controller 710 may control a duty cycle between the third PMOS transistor M_{P3} and the third NMOS transistor M_{N3}. For example, the second PWM controller 710 may increase the turn-on time of the third PMOS transistor M_{P3} when the second regulation voltage V_{C2} is less than the voltage V_{SAW2} of the AC waveform. That is, the second PWM controller 710 may increase the turn-on time of the third PMOS transistor M_{P3} within one cycle in which the third NMOS transistor M_{N3} and the third PMOS transistor M_{P3} are alternately turned on to increase the voltage level of the second output voltage V_{OUT2}. For another example, the second PWM controller 710 may reduce the turn-on time of the third PMOS transistor M_{P3} when the second regulation voltage V_{C2} is greater than the voltage V_{SAW2} of the AC waveform. That is, the second PWM controller 710 may reduce the turn-on time of the third PMOS transistor M_{P3} within one cycle in which the third NMOS transistor M_{N3} and the third PMOS transistor M_{P3} are alternately turned on to reduce the voltage level of the second output voltage V_{OUT2}.

FIG. 7B is a flowchart illustrating a method of operating a hybrid buck converter 700 according to an embodiment.

Referring to FIG. 7B, in operation S710, the hybrid buck converter 700 may receive a voltage level of the second output voltage V_{OUT2}. For example, the GM cell 701 may receive the sensing value of the second output voltage V_{OUT2} of the second output node OUT₂ as an input of one of the differential inputs.

In operation S720, the GM cell 701 of the hybrid buck converter 700 may generate the second regulation voltage V_{C2} based on the second output voltage V_{OUT2} and the second reference voltage V_{REF2}. For example, the GM cell 701 of the hybrid buck converter 700 may output the second regulation voltage V_{C2} based on the second output voltage V_{OUT2} and the second reference voltage V_{REF2} received in operation S710. The second reference voltage V_{REF2} may be a reference voltage for controlling whether to set the voltage level of the second output voltage V_{OUT2} to be close to the power voltage V_{DD} or to be close to the first output node V_{OUT1}.

In operation S730, the hybrid buck converter 700 may control a pulse width ratio of the third PMOS transistor M_{P3} and the third NMOS transistor M_{N3} based on a comparison between the second regulation voltage V_{C2} and the AC waveform voltage V_{SAW2}. For example, when the second regulation voltage V_{C2} is greater than the voltage V_{SAW2} of the AC waveform, the second PWM controller 710 may control the pulse width ratio to reduce the turn-on time of the third PMOS transistor M_{P3}. Accordingly, the second regulation voltage V_{C2} may gradually decrease to converge to the intermediate value of the voltage V_{SAW2} of the AC waveform. For another example, when the second regulation voltage V_{C2} is less than the voltage V_{SAW2} of the AC waveform, the second PWM controller 710 may control the pulse width ratio to increase the turn-on time of the third PMOS transistor M_{P3}. Accordingly, the second regulation voltage V_{C2} may gradually increase to converge to the intermediate value of the voltage V_{SAW2} of the AC waveform.

FIG. 7C illustrates an example of a reduction in power loss according to an embodiment.

Referring to FIG. 7C, a voltage level of the second output node OUT₂ is illustrated. The shunt regulator according to the comparative example of FIG. 3A is driven based on the power supply voltage V_{DD}. Accordingly, the power loss of the hybrid buck converter 300 according to the comparative example is as follows.

$$PL = {I}_{SHUNT} * {V}_{DROP 1} = {I}_{SHUNT} * ( {V}_{DD} - {V}_{OUT 1} ) \qquad [ Equation 3 ]$$

Referring to FIG. 4, when the shunt regulator 420 is driven based on the second output node OUT₂ regulated according to embodiments disclosed herein, the driving voltage of the shunt regulator 420 may be reduced from the power voltage V_{DD} to the second output voltage V_{OUT2}. Accordingly, a power loss of the hybrid buck converter 700 according to embodiments is as follows.

$$PL = {I}_{SHUNT} * {V}_{DROP 2} = {I}_{SHUNT} * ( {V}_{OUT 2} - {V}_{OUT 1} ) \qquad [ Equation 4 ]$$

Here, it may be seen that since the second output voltage V_{OUT2} is less than the power voltage V_{DD}, the magnitude of the voltage drop is reduced, and accordingly, the magnitude of power loss is also reduced. That is, the hybrid buck converter 700 may reduce power loss by changing the voltage for driving the shunt regulator 420 from the power voltage V_{DD} to the second output voltage V_{OUT2}.

FIG. 7D is a graph illustrating an example in which a second reference voltage V_{ref2} is varied according to an embodiment.

Referring to FIG. 7D, the second reference voltage V_{REF2} may be changed to any one of a first voltage V₁ to a third voltage V₃ based on a frequency of dynamic voltage scaling. According to an embodiment, the control circuit 220 of the PMIC 200 of FIG. 2 may generate a first control signal at a first time T1. The first control signal may be a signal instructing to set the magnitude of the second reference voltage V_{REF2} to the first voltage V₁. The control circuit 220 of FIG. 2 may track the number of occurrences of dynamic voltage scaling during a predetermined period. The control circuit 220 may generate the first control signal when dynamic voltage scaling occurs an appropriate number of times. For example, when the number of occurrences of dynamic voltage scaling during a certain period is greater than the first value and less than the second value, the control circuit 220 may generate the first control signal. The second value may be greater than the first value.

According to an embodiment, the control circuit 220 of the PMIC 200 of FIG. 2 may generate a second control signal at a second time T2. The second control signal may be a signal instructing to set the magnitude of the second reference voltage V_{REF2} to a second voltage V₂. The magnitude of the second voltage V₂ may be greater than the magnitude of the first voltage V₁. That is, the second control signal may be a signal for setting the magnitude of the second output voltage V_{OUT2} of the second output node OUT₂ to be high. The control circuit 220 may identify whether dynamic voltage scaling occurs very often after the first time T1. For example, when the number of occurrences of the dynamic voltage scaling during a certain period of time exceeds the second value, the control circuit 220 may generate the second control signal to change the voltage level of the second output voltage V_{OUT2} to be close to the power voltage V_{DD}. When dynamic voltage scaling occurs frequently, the number of times that the shunt regulation 420 is driven may also increase. When the second output voltage V_{OUT2} is set to be low (e.g., a value similar to the first output voltage V_{OUT1}), the second output voltage V_{OUT2} is not high enough to drive the shunt regulation 420 at the time when dynamic voltage scaling occurs, and thus, it may be regarded as a defect that the transient states of the first output voltage V_{OUT1} and the load current I_{LOAD} may be maintained for a long time. To prevent or reduce the likelihood of this occurring, the control circuit 220 may set the second output voltage V_{OUT2} to be high so that the shunt regulator 420 may be driven at all times in an environment where dynamic voltage scaling frequently occurs.

According to embodiments, the control circuit 220 of the PMIC 200 may generate a third control signal at a third time T3. The third control signal may be a signal instructing to set the magnitude of the second reference voltage V_{REF2} to the third voltage V₃. The magnitude of the third voltage V₃ may be less than that of the first voltage V₁ and the second voltage V₂. That is, the third control signal may be a signal for setting the voltage level of the second output voltage V_{OUT2} of the second output node OUT₂ to be low (e.g., very close to the first output voltage V_{OUT1}). The control circuit 220 may identify whether dynamic voltage scaling hardly occurs after the second time T2. For example, when the number of occurrences of dynamic voltage scaling during a predetermined period is less than the first value, the control circuit 220 may generate the third control signal to change the voltage level of the second output voltage V_{OUT2} to approximate the first output voltage V_{OUT1}. When dynamic voltage scaling hardly occurs, the number of times that the shunt regulation 420 is driven may also decrease. When the second output voltage V_{OUT2} is set to be high (e.g., a value similar to the power supply voltage V_{DD}), the magnitude of power loss generated by the shunt regulator 420 may increase. Therefore, to increase power efficiency by reducing power loss generated by the shunt regulator 420, the control circuit 220 may set the second output voltage V_{OUT2} to be low in an environment where dynamic voltage scaling rarely occurs.

FIG. 8A is a circuit diagram of a hybrid buck converter 800 including a hysteresis controller 810 according to an embodiment, and FIG. 8B illustrates an example of a third reference voltage V_{REF3} according to an embodiment.

Referring to FIG. 8A, the hybrid buck converter 800 may further include a hysteresis controller 810 in addition to the hybrid buck converter 400 of FIG. 4.

According to an embodiment, the hysteresis controller 810 may control turn-on or turn-off of the fourth NMOS transistor M_{N4}. For example, the hysteresis controller 810 may receive a third reference voltage V_{REF3} and a third output voltage V_{OUT3}. The hysteresis controller 810 may turn on or off the fourth NMOS transistor M_{N4} in response to the third output voltage V_{OUT3} being out of a predetermined range from the third reference voltage V_{REF3}.

Referring to FIG. 8B together with FIG. 8A, the fourth NMOS transistor M_{N4} may be turned on when the third output voltage V_{OUT3} exceeds a value obtained by adding the window voltage V_{WINDOW} to the third reference voltage V_{REF3}. Because the third output capacitor C_{OUT3} is charged enough to exceed the sum of the window voltage V_{WINDOW} and the third reference voltage V_{REF3}, the hysteresis controller 810 may turn on the fourth NMOS transistor M_{N4} to generate the inductor current I_{IND} using the charge stored in the third output capacitor C_{OUT3}. The hysteresis controller 810 may turn on the fourth NMOS transistor M_{N4} and simultaneously turn off the first NMOS transistor M_{N1}. That is, the fourth NMOS transistor M_{N4} and the first NMOS transistor M_{N1} may be alternately turned on.

Referring to FIG. 8B together with FIG. 8A, the fourth NMOS transistor M_{N4} may be turned off when the third output voltage V_{OUT3} is less than a value obtained by subtracting the window voltage V_{WINDOW} to the third reference voltage V_{REF3}. When the third output voltage V_{OUT3} decreases to less than a value obtained by subtracting the window voltage V_{WINDOW} from the third reference voltage V_{REF3}, most of the charges stored in the third output capacitor C_{OUT3} may have been used. The hysteresis controller 810 may turn off the fourth NMOS transistor M_{N4} to electrically separate the third output node OUT₃ from the first switching node L_{X1}. The hysteresis controller 810 may turn off the fourth NMOS transistor M_{N4} and simultaneously turn on the first NMOS transistor M_{N1}. Thereafter, the third output capacitor C_{OUT3} may be charged using the current discharged from the first output node OUT₁ through the coarse NMOS transistor M_{CN}, and when the third output voltage V_{OUT3} exceeds the sum of the third reference voltage V_{REF3} and the window voltage V_{WINDOW}, the fourth NMOS transistor M_{N4} may be turned on again.

According to various embodiments, the hysteresis controller 810 may variably set the optimal window voltage V_{WINDOW} for reusing the charge stored in the third output capacitor C_{OUT3} based on the turn-on or turn-off control history of the fourth NMOS transistor M_{N4}.

FIG. 8C is a flowchart illustrating a method of operating a hybrid buck converter 800 according to an embodiment.

Referring to FIG. 8C, in operation S810, the hybrid buck converter 800 may receive a voltage level of the second output voltage V_{OUT3}. For example, the hysteresis controller 810 may receive, as one input, the sensing value of the third output voltage V_{OUT3} of the third output node OUT₃.

In operation S820, the hybrid buck converter 600 may control the first NMOS transistor M_{N1} and the fourth NMOS transistor M_{N4} based on the third output voltage V_{OUT3}, the third reference voltage V_{REF3} and the window voltage V_{WINDOW}. For example, the hysteresis controller 810 may turn on the fourth NMOS transistor M_{N4} and turn off the first NMOS transistor M_{N1} when the third output voltage V_{OUT3} exceeds a value obtained by adding the window voltage V_{WINDOW} to the third reference voltage V_{REF3}. For another example, the hysteresis controller 810 may turn off the fourth NMOS transistor M_{N4} and turn on the first NMOS transistor M_{N1} when the third output voltage V_{OUT3} is less than a value obtained by subtracting the window voltage V_{WINDOW} from the third reference voltage V_{REF3}.

According to the embodiments described above, the push-pull controller 510 for controlling the shunt regulator 420 is shown in FIG. 5A, the first PWM controller 610 for controlling the inductor current I_{IND} is shown in FIG. 6A, the second PWM controller 710 for controlling the second output voltage V_{OUT2} is shown in FIG. 7A, and the hysteresis controller 810 for controlling the third output voltage V_{OUT3} is shown in FIG. 8A. However, the push-pull controller 510, the first PWM controller 610, the second PWM controller 620, and the hysteresis controller 810 do not operate separately but may operate concurrently. That is, the hybrid buck converter 400 of FIG. 4 may be controlled simultaneously and/or independently by the push-pull controller 510 of FIG. 5A, the first PWM controller 610 of FIG. 6A, the second PWM controller 710 of FIG. 7A, or the hysteresis controller 810 of FIG. 8A.

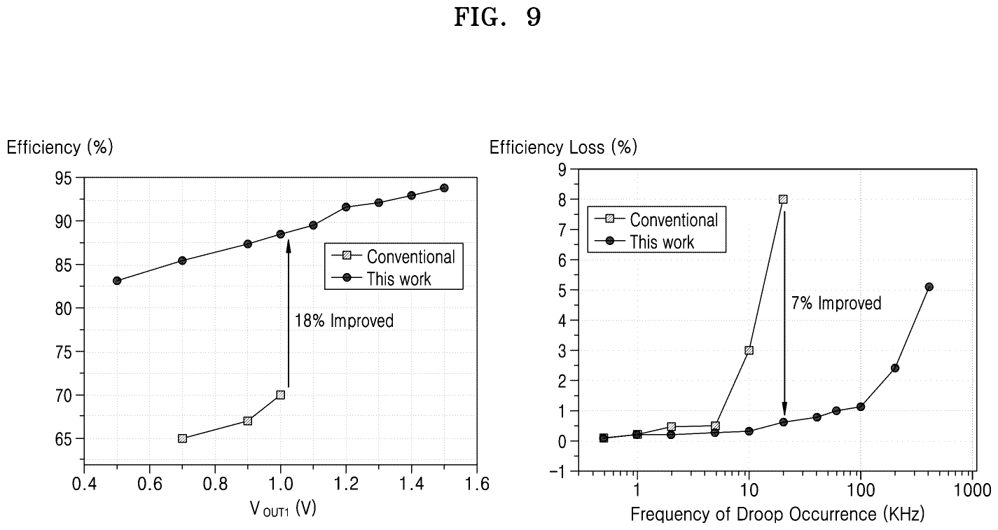

FIG. 9 is a pair of graphs that illustrate efficiency improvement of a hybrid buck converter according to an embodiment.

Referring to FIG. 9, a first graph on the left side shows how much efficiency is improved according to the first output voltage V_{OUT1}. For example, in the case of the hybrid buck converter according to the comparative example, the efficiency is about 70% when the first output voltage V_{OUT1} is 1 V, whereas in the case of the hybrid buck converter according to the embodiment, it may be confirmed that the efficiency exceeds about 85%. This efficiency improvement may be based on driving the shunt regulator to the second output voltage V_{OUT2} regulated from the first output voltage V_{OUT1} without driving the shunt regulator based on the power voltage V_{DD}, thereby reducing the magnitude of the voltage drop that causes power loss, and reducing the magnitude of the current based on the shunt regulator by always maintaining the inductor current I_{IND} to be β times the shunt current I_{SHUNT}.

A second graph on the right side shows how much the efficiency loss is improved according to the frequency of dynamic voltage scaling. For example, when the frequency of dynamic voltage scaling is 10 KHz, it may be confirmed that the efficiency loss is about 3% in the case of the hybrid buck converter according to the comparative example. However, in the case of the hybrid buck converter according to an embodiment, it may be confirmed that the efficiency loss is reduced to about 0.7%. This decrease in the efficiency loss may be based on driving the shunt regulator to the second output voltage V_{OUT2} regulated from the first output voltage V_{OUT1} without driving the shunt regulator based on the power voltage V_{DD}, thereby reducing the magnitude of the voltage drop that causes power loss, reducing the magnitude of the current based on the shunt regulator by always maintaining the inductor current I_{IND} to be β times the shunt current I_{SHUNT}, storing the discharge current discharged from the shunt regulator in the third capacitor C_{OUT3} and reusing the stored charge to generate the inductor current I_{IND}.

While embodiments of the inventive concept have been particularly shown and described with reference to embodiments thereof, it will be understood that various changes in form and details may be made therein without departing from the spirit and scope of the following claims.

What is claimed is:

1. A hybrid buck converter comprising:
a buck converter including a first P-channel metal oxide semiconductor (PMOS) transistor, a second PMOS transistor, a first N-channel metal oxide semiconductor (NMOS) transistor, a second NMOS transistor, and an inductor, wherein the first and second PMOS transistors electrically connect a power supply voltage node with a first switching node, the first and second NMOS transistors electrically connect a ground node with the first switching node, and the inductor electrically connects the first switching node with a second switching node;
a third NMOS transistor electrically connecting the second switching node with a first output node;
a third PMOS transistor electrically connecting the second switching node with a second output node;
a shunt regulator that is driven based on a second output voltage corresponding to the second output node;
a first pulse width modulation (PWM) controller configured to adjust, based on a pulse width control of the first PMOS transistor and the first NMOS transistor, a magnitude of an inductor current passing through the inductor; and
a second PWM controller configured to adjust, based on a pulse width control of the first PMOS transistor and the first NMOS transistor, a magnitude of the second output voltage.

2. The hybrid buck converter of claim 1, wherein the shunt regulator comprises:
a fine PMOS transistor electrically connected to the second output node and the first output node; a coarse PMOS transistor electrically connected in parallel to the fine PMOS transistor; and a coarse NMOS transistor electrically connected to the first output node and a third output node, and
the hybrid buck converter further comprises a push-pull controller configured to control a magnitude of a shunt current provided from the shunt regulator to the first output node, by generating first control signals for the coarse PMOS transistor, second control signals for the fine PMOS transistor, and third control signals for the coarse NMOS transistor, based on a result of comparing a first output voltage corresponding to the first output node with a first reference voltage.

3. The hybrid buck converter of claim 2, wherein the first PWM controller is configured to adjust a pulse width ratio between the first PMOS transistor and the first NMOS transistor, such that the inductor current becomes equal to N times the shunt current, wherein N is a natural number.

4. The hybrid buck converter of claim 3, wherein the first PWM controller is configured to: when the inductor current is greater than N times the shunt current, increase a duty cycle of the first PMOS transistor; and when the inductor current is less than N times the shunt current, reduce the duty cycle of the first PMOS transistor, and
wherein the first NMOS transistor and the first PMOS transistor are alternately turned on.

5. The hybrid buck converter of claim 2, wherein the first reference voltage varies based on dynamic voltage scaling.

6. The hybrid buck converter of claim 1, wherein the second PWM controller is configured to adjust a pulse width ratio between the third PMOS transistor and the third NMOS transistor, such that the second output voltage becomes equal to a second reference voltage, based on a result of comparing the second output voltage with the second reference voltage.

7. The hybrid buck converter of claim 6, wherein the second PWM controller is configured to: when the second output voltage exceeds the second reference voltage, reduce a duty cycle of the third PMOS transistor; and when the second output voltage is less than the second reference voltage, increase the duty cycle of the third PMOS transistor, and
wherein the third NMOS transistor and the third PMOS transistor are alternately turned on.

8. The hybrid buck converter of claim 6, wherein the second reference voltage varies based on a frequency of dynamic voltage scaling.

9. The hybrid buck converter of claim 2, further comprising:
a third output capacitor between the third output node and the ground node;
a fourth NMOS transistor electrically connecting the third output node with the first switching node; and
a hysteresis controller configured to turn on the fourth NMOS transistor, based on a result of comparing a third output voltage corresponding to the third output node with a third reference voltage.

10. The hybrid buck converter of claim 9, wherein the hysteresis controller is further configured to:
when the third output voltage exceeds a sum of the third reference voltage and a window voltage, turn on the fourth NMOS transistor and turn off the first NMOS transistor; and
when the third output voltage is less than a value obtained by subtracting the window voltage from the third reference voltage, turn off the fourth NMOS transistor and turn on the first NMOS transistor.

11. An operation method of a hybrid buck converter including a buck converter and a shunt regulator, the operation method comprising:
determining whether an inductor current passing through an inductor of the buck converter is N times a shunt current output from the shunt regulator;
performing pulse width control between a high-side switching element and a low-side switching element of the buck converter, according to the determining;
performing pulse width control between a third NMOS transistor and a third PMOS transistor, based on a result of comparing a second output voltage with a second reference voltage, wherein
the high-side switching element electrically connects a power supply voltage with a first switching node corresponding to a first end of the inductor,
the low-side switching element electrically connects a ground node with the first switching node,
the third PMOS transistor electrically connects a second output node corresponding to the second output voltage with a second switching node corresponding to a second end of the inductor, and
the third NMOS transistor electrically connects the second switching node with a first output node corresponding to a first output voltage.

12. The operation method of claim 11, wherein
the shunt regulator comprises: a fine PMOS transistor electrically connected to the second output node and the first output node; a coarse PMOS transistor electrically connected in parallel to the fine PMOS transistor; and a coarse NMOS transistor electrically connected to the first output node and a third output node, and
the operation method further comprises: comparing the first output voltage with a first reference voltage; generating first control signals for the coarse PMOS transistor, second control signals for the fine PMOS transistor, and third control signals for the coarse NMOS transistor, based on a result of the comparison; and controlling a magnitude of the shunt current, based on the control signals.

13. The operation method of claim 12, wherein the performing of pulse width control between the high-side switching element and the low-side switching element further comprises:
identifying that the inductor current is greater than N times the shunt current; and
increasing a duty cycle of the high-side switching element, based on the identification.

14. The operation method of claim 12, wherein the performing a pulse width control between the high-side switching element and the low-side switching element further comprises:
identifying that the inductor current is less than N times the shunt current; and
reducing a duty cycle of the high-side switching element, based on the identification.

15. The operation method of claim 12, wherein the first reference voltage varies based on dynamic voltage scaling.

16. The operation method of claim 11, wherein the performing of pulse width control between the third NMOS transistor and the third PMOS transistor further comprises:
identifying that the second output voltage exceeds the second reference voltage; and
reducing a duty cycle of the third PMOS transistor, based on the identification.

17. The operation method of claim 11, wherein the performing of pulse width control between the third NMOS transistor and the third PMOS transistor further comprises:
identifying that the second output voltage is less than the second reference voltage; and
increasing a duty cycle of the third PMOS transistor, based on the identification.

18. The operation method of claim 11, wherein the second reference voltage varies based on a frequency of dynamic voltage scaling.

19. The operation method of claim 12, further comprising: comparing a third output voltage with a third reference voltage; and turning on or off a fourth NMOS transistor, based on the determining, wherein
the third output voltage is based on a third capacitor electrically connecting the third output node with the ground node, and the fourth NMOS transistor electrically connects the third output node with the first switching node.

20. The operation method of claim 19, further comprising:
when the third output voltage exceeds a sum of the third reference voltage and a window voltage, turning on the fourth NMOS transistor; and
when the third output voltage is less than a value obtained by subtracting the window voltage from the third reference voltage, turning off the fourth NMOS transistor.
